(19) United States
(12) Patent Application Publication
(10) Pub. No.: US 2013/0336249 A1
(43) Pub. Date: Dec. 19, 2013

(54) APPARATUS AND METHODS FOR RESOURCE ELEMENT GROUP BASED TRAFFIC TO PILOT RATIO AIDED SIGNAL PROCESSING

(71) Applicant: QUALCOMM Incorporated, San Diego, CA (US)

(72) Inventors: Lu ZHAO, Nuremberg (DE); Tao LUO, San Diego, CA (US); Taesang YOO, San Diego, CA (US); Siddhartha MALLIK, San Diego, CA (US); Yongbin WEI, San Diego, CA (US); Durga Prasad MALLADI, San Diego, CA (US)

(21) Appl. No.: 13/916,437

(22) Filed: Jun. 12, 2013

Related U.S. Application Data
(60) Provisional application No. 61/660,652, filed on Jun. 15, 2012.

(51) Int. Cl. H04W 72/04

(52) U.S. Cl. CPC H04W 72/0406
USPC 370/329

(57) ABSTRACT

A method, a computer program product, and an apparatus are provided. The methods and apparatus for wireless communication include receiving a transmission, the transmission including a plurality of resource element groups (REGs). Aspects of the methods and apparatus include selecting a set of REGs from the plurality of REGs, the set of REGs including at least one REG and determining a traffic to pilot ratio (TPR) for the set of REGs based on the transmission and reference signals in the transmission. Aspects of the methods and apparatus include determining whether the set of REGs includes at least one of control information or data based on the TPR and canceling at least one of control information or data from the set of REGs based on the TPR.

### CLAIM OF PRIORITY UNDER 35 U.S.C §119

The present Application for Patent claims priority to U.S. Provisional Application No. 61/660,652 entitled “APPARATUS AND METHODS FOR RESOURCE ELEMENT GROUP BASED TRAFFIC TO PILOT RATIO AIDED SIGNAL PROCESSING” filed Jun. 15, 2012, and assigned to the assignee hereof and hereby expressly incorporated by reference.

### BACKGROUND

1. Field

The present disclosure relates generally to communication systems, and more particularly, to resource element group (REG) based traffic to pilot ratio (TPR) aided signal processing, thereby providing consistent service in a wireless communication system.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Thus, aspects of this apparatus and method for resource element group (REG) based traffic to pilot ratio (TPR) aided signal processing, thereby providing consistent service in a wireless communication system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various aspects of this disclosure may be directed to methods and apparatuses that receive a plurality of REGs. These REGs may include reference signals and traffic signals from nearby cells. The UE may select a set of REGs from the plurality of REGs. This set of REGs which may include one or more REGs. The REGs in the set may be grouped based on various criteria or may include only one REG. The UE may determine a TPR for each of the nearby cells that is transmitting in the set of REGs, and may cancel the signal and traffic in the REGs from each of the nearby cells in proportion to the respective TPRs calculated for each cell.

A method for REG based TPR aided signal processing is provided that includes receiving a transmission, the transmission including a plurality of REGs. The method also includes selecting a set of REGs from the plurality of REGs, the set of REGs including at least one REG and determining a TPR for the set of REGs based on the transmission and reference signals in the transmission. Additionally, the method includes determining whether the set of REGs includes at least one of control information or data based on the TPR and canceling at least one of control information or data from the set of REGs based on the TPR.

In another aspect, an apparatus for REG based TPR aided signal processing is provided that includes a processor configured to receive a transmission, the transmission including a plurality of REGs. The processor is also configured to select a set of REGs from the plurality of REGs, the set of REGs including at least one REG and determine a TPR for the set of REGs based on the transmission and reference signals in the transmission. Additionally, the processor is configured to determine whether the set of REGs includes at least one of control information or data based on the TPR and cancel at least one of control information or data from the set of REGs based on the TPR.

In another aspect, an apparatus for REG based TPR aided signal processing is provided that includes means for receiving a transmission, the transmission including a plurality of REGs. The apparatus also includes means for selecting a set of REGs from the plurality of REGs, the set of REGs including at least one REG and means for determining a TPR for the set of REGs based on the transmission and reference signals in the transmission. Additionally, the apparatus includes means for determining whether the set of REGs includes at least one of control information or data based on the TPR and means for canceling at least one of control information or data from the set of REGs based on the TPR.

In yet another aspect, a computer-readable media for REG based TPR aided signal processing is provided that includes machine-executable code for receiving a transmission, the transmission including a plurality of REGs. The code may also be executable for selecting a set of REGs from the plurality of REGs, the set of REGs including at least one REG and determining a TPR for the set of REGs based on the transmission and reference signals in the transmission. Additionally, the code may be executable for determining whether the set of REGs includes at least one of control information or data based on the TPR and canceling at least one of control information or data from the set of REGs based on the TPR.

These and other aspects of the disclosure will become more fully understood upon a review of the detailed description, which follows.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example of communication between multiple cellular towers and multiple UEs.

FIG. 8 is a schematic diagram illustrating collisions and partial collision between a serving cell and an interfering cell for multiple REGs.

FIG. 9 is a schematic diagram illustrating an exemplary aspect of call processing of a UE in a wireless communication system.

FIG. 10 is another schematic diagram illustrating an exemplary aspect of call processing of a UE in a wireless communication system.

FIG. 11 is flow chart illustrating a first exemplary method of wireless communication between a UE and a cell.

FIG. 12 is a flow chart illustrating a second exemplary method of wireless communication between a UE and a cell.

FIG. 13 is a conceptual data flow diagram illustrating the data flow between different modules/means/components in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As noted above, the increased demand for high data rate and better coverage service has become a driving factor of developing heterogeneous wireless network. Indeed, heterogeneous network will enhance the cellular network's throughput and also offer overlapping coverage to a UE. However, in the integration process of heterogeneous wireless network, many harsh interference scenarios may occur. For example, a UE may not be able to access the strongest cell (femto) if that femto is part of a closed subscriber group, in which case the UE has to connect to weaker cell. This case, poses challenges with respect to cancellation of the strong inference for various control and data channels. One such challenge involves the interference cancellation of Physical Downlink Control Channel (PDCCH), Physical Control Format Indicator Channel (PCFICH), or Physical HybridARQ Indicator Channel (PHICH) signals.

A PDCCH, PCFICH, or PHCIH carries scheduling assignment and other control information. In each subframe, there is various way of transmitting PDCCH, PCFICH, or PHCIH in terms of tone location, payload format, and Radio Network Temporary Identifier (RNTI) values associated with cycle redundancy check (CRC) mask/demask operation. At the receiver side, a UE needs to go through multiple hypotheses via blind decoding in order to detect the correct PDCCH, PCFICH, or PHCIH, since the assignment information is not known at the receiver. Thus, the complexity of PDCCH, PCFICH, or PHCIH detection for serving cell case is high. In case of PDCCH, PCFICH, or PHCIH where UE does not know the RNTI value of interfering cell, which plays a key role in identifying the search spaces of PDCCH, PCFICH, or PHCIH transmissions, PDCCH, PCFICH, or PHCIH detection of interfering cell becomes challenging.

Thus, aspects of this apparatus and method provide for REG based TPR aided signal processing, thereby providing consistent service in a wireless communication system.

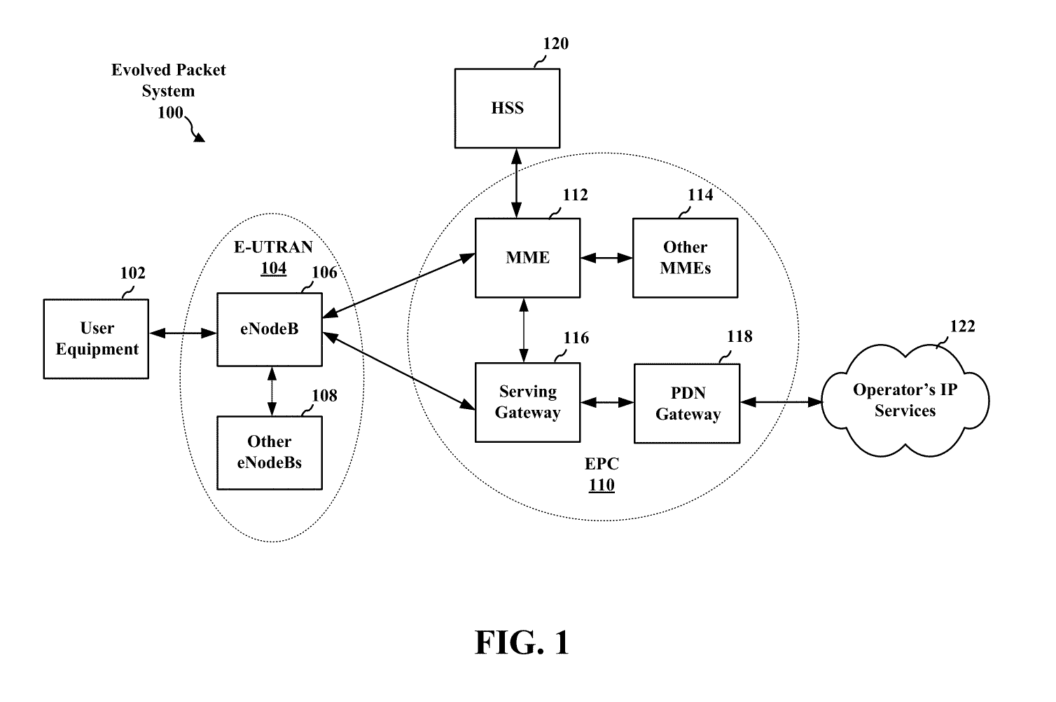

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

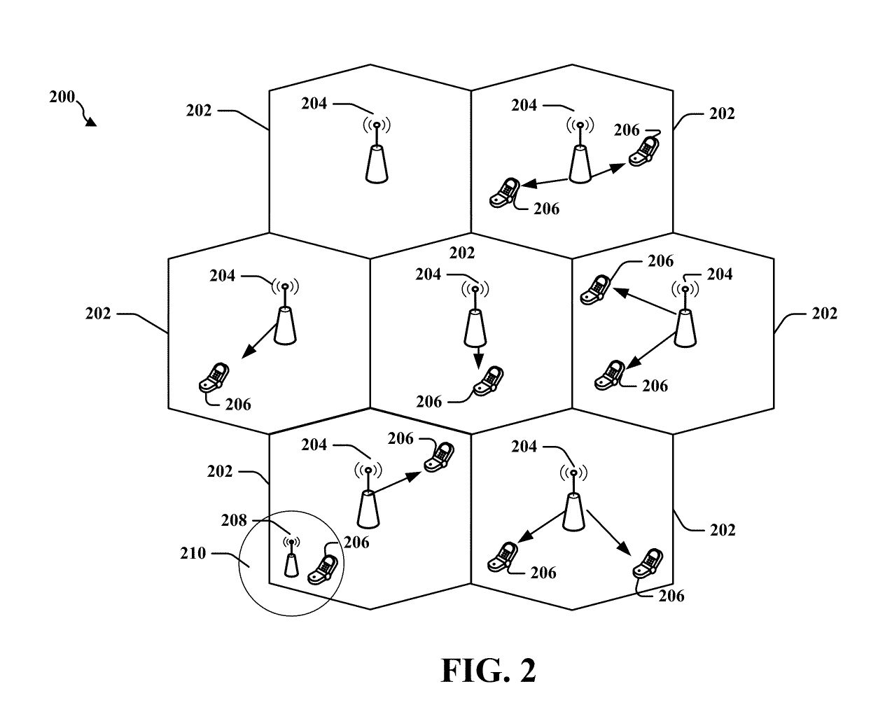

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both FDD and TDD. As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

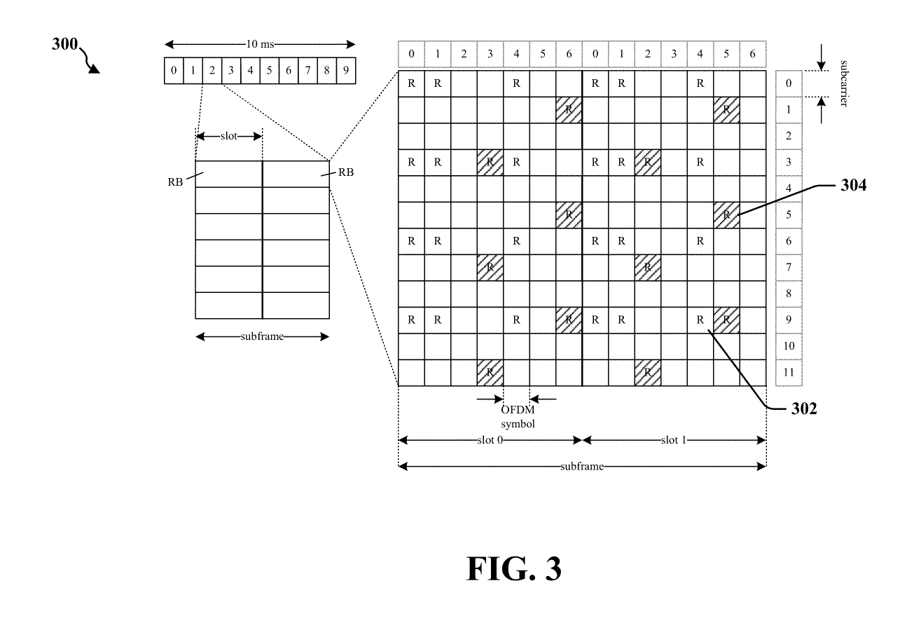

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements per resource block. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

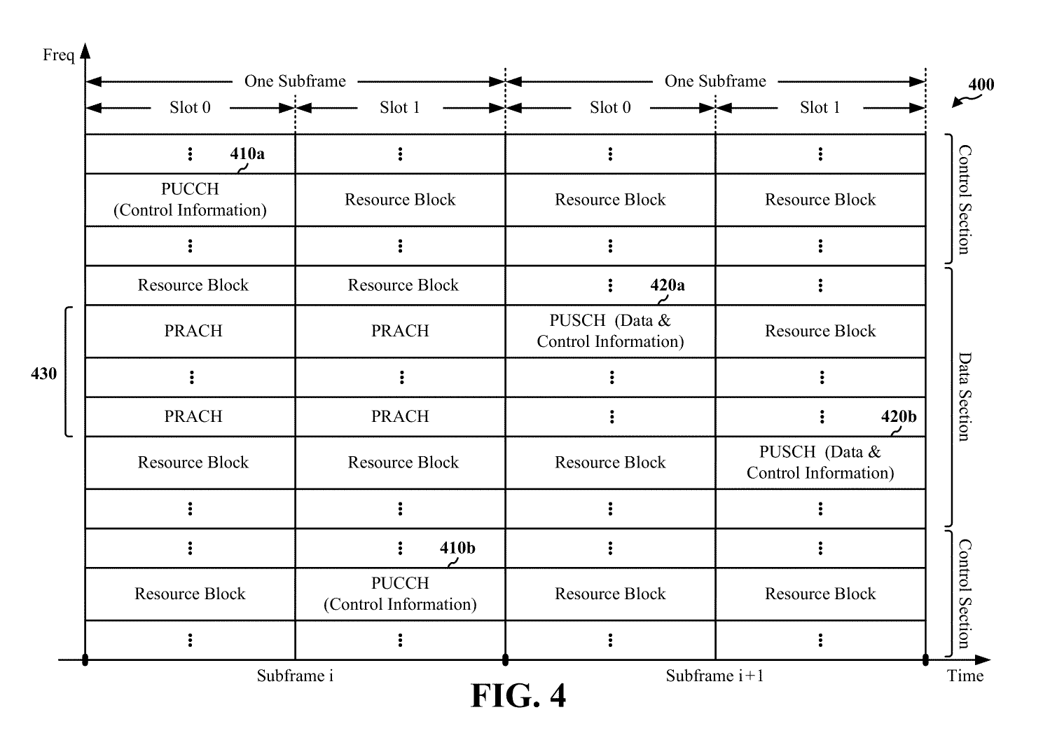

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

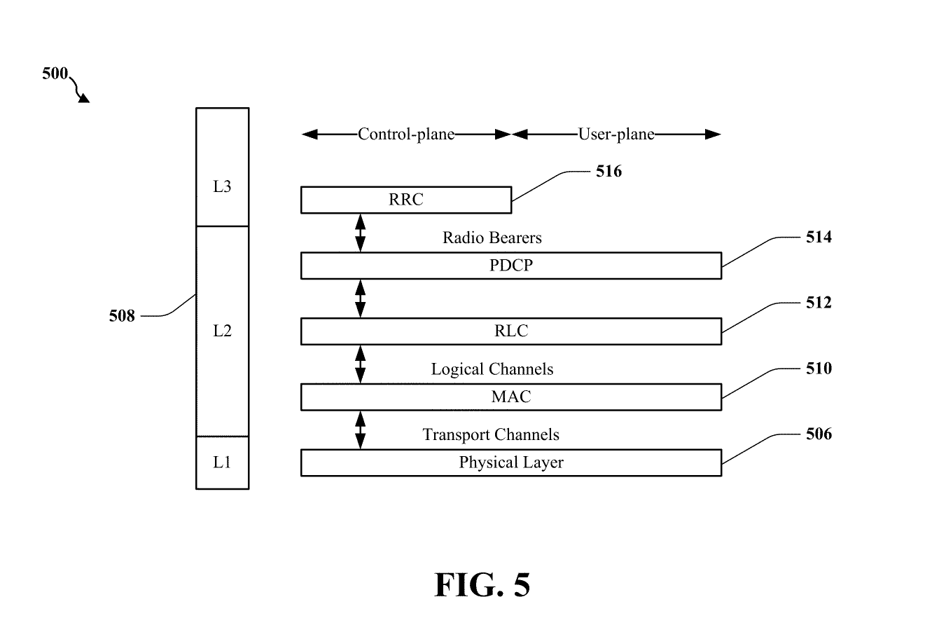

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

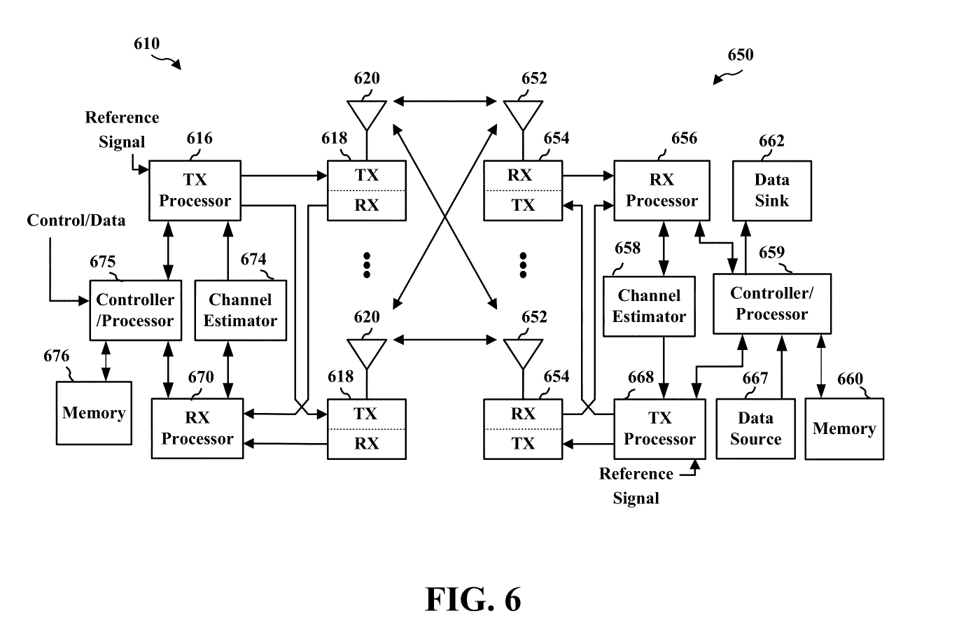

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

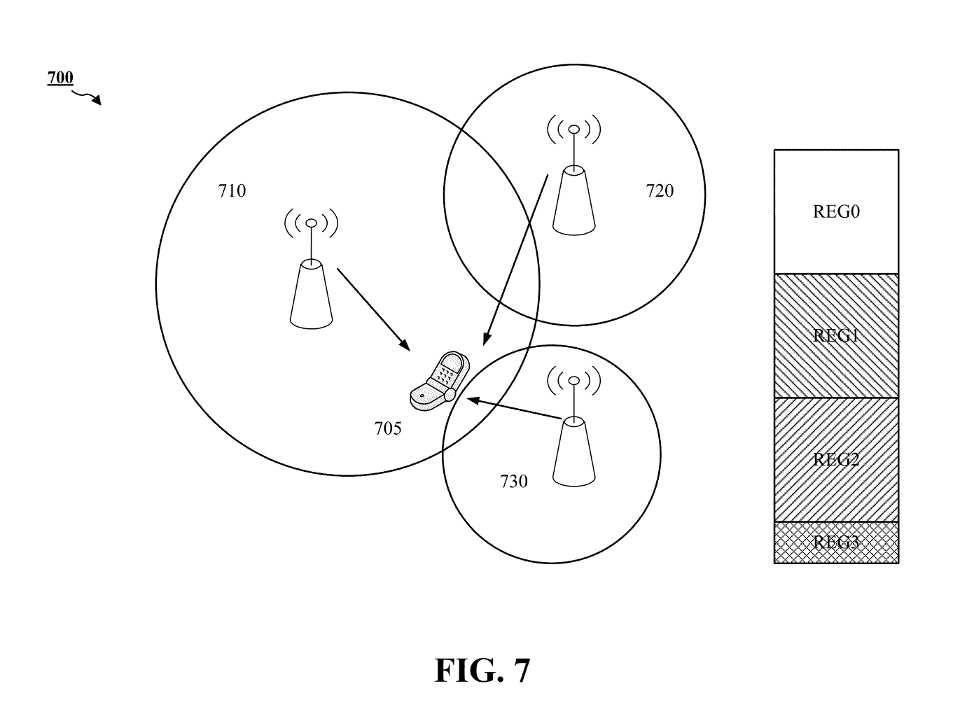

FIG. 7 is a diagram illustrating an example of communication between multiple cellular towers and multiple UEs. Diagram 700 also illustrates, in one aspect, a typical interference scenario during UE communication with multiple cellular towers. UE 705 receives a plurality of resource element groups REG0, REG1, REG2, and REG3. Based on the symbol on which the REGs are received, the REGs may include reference signals from cells 710, 720, and 730. Specifically, in symbol 0 and possibly symbol 1, depending on the configuration, the REGs may include reference signals. In this example, REG0 includes signals from serving cell 710, REG1 includes signals from neighboring second cell 720, REG2 includes signals from neighboring third cell 730, and REG3 includes signals from all cell 710, 720, and 730.

In one aspect UE 705 may select a set of REGs (any one of REG0, REG1, REG2, or REG3) from the plurality of REGs and determine the TPR based on received reference PDCCH, PCFICH, or PHCIH signals in the set of REGs. The set of REGs may be selected based on various criteria, such as frequency ranges, adjacency, consecutive location in a RB, a minimum symbol size, a maximum symbol size, another criteria, or may be selected randomly. For example, the UE may calculate a separate TPR for each of the cell transmissions in the set of REGs, respectively, based on the pilot and traffic condition in the REGs corresponding to each cell and based on the received reference PDCCH, PCFICH, or PHCIH signals in the set of REGs. For each of the cells, the UE 705 may determine whether the set of REGs includes control information or data from the respective cells based on the TPR. In one aspect, if the UE 705 determines that there is control information or data in the set of REGs, the UE 705 may cancel the control information or data from the set of REGs based on the determined TPR. Specifically, the UE 705 may determine whether the set of REGs includes signals from interfering cells and if so determined, the signals from the interfering cells are canceled. It should be noted the signals from interfering cells may be PDCCH, PCFICH, or PHCIH signals and that the PDCCH, PCFICH, or PHCIH signals may be transmitted on various REGs in the control region.

The UE 705, in another aspect, may determine if the set of REGs include a first transmission from a serving cell 710 and a second transmission from a neighboring second cell 720. When UE 705 determines that the set of REGs includes a first transmission and a second transmission and the determined TPR corresponds to the second transmission, the UE 705 generates a modified transmission by cancelling the second transmission from the first transmission based on the determined TPR. Finally, UE 705 may then determine a modified TPR for the first transmission based on the modified transmission for proper (noise-reduced) communication with serving cell 710.

For example, UE 705 may received a desired PDCCH, PCFICH, or PHCIH signal from serving cell 710, while at the same time receiving a stronger PDCCH, PCFICH, or PHCIH interference signal from neighboring second cell 720. UE 705 may then determine the TPR of the PDCCH, PCFICH, or PHCIH signal of serving cell 710 and the TPR of the PDCCH, PCFICH, or PHCIH signal of neighboring second cell 720. UE 705 may then isolate resource blocks of the PDCCH, PCFICH, or PHCIH signal of serving cell 710 and the resource blocks of the PDCCH, PCFICH, or PHCIH signal of neighboring second cell 720. Afterwhich, the PDCCH, PCFICH, or PHCIH interference signal of neighboring second cell 720 may then be canceled from the total received signal by UE 705 in order to ensure that only the desired PDCCH, PCFICH, or PHCIH signal from serving cell 710 is processed.

In another aspect where UE 705 receives a third transmission from neighboring third cell 730, the UE may cancel the transmission of neighboring third cell 730 in a manner similar to the cancellation of transmission signal from neighboring second cell 720, as discussed above. In this way, UE 705 may iteratively cancel all interfering transmissions to allow for proper (noise-reduced) communication with serving cell 710.

Although diagram 700 illustrates only three cells 710, 720, and 730, additional cells may send undesired signals to UE 705. The signals from the additional cells may further be iteratively cancelled in the manner discussed above.

Furthermore, the process may operate recursively, whereby after the UE determines the impact on the set of REGs from cells 720 and 730, and noise, the UE may recompute a new TPR for serving cell 710 based on this information. The UE may then cancel the serving cell 710 signal from set of REGs, and then proceeed to compute a new TPRs for cells 720 and 730 and cancel those signals based on the new TPRs.

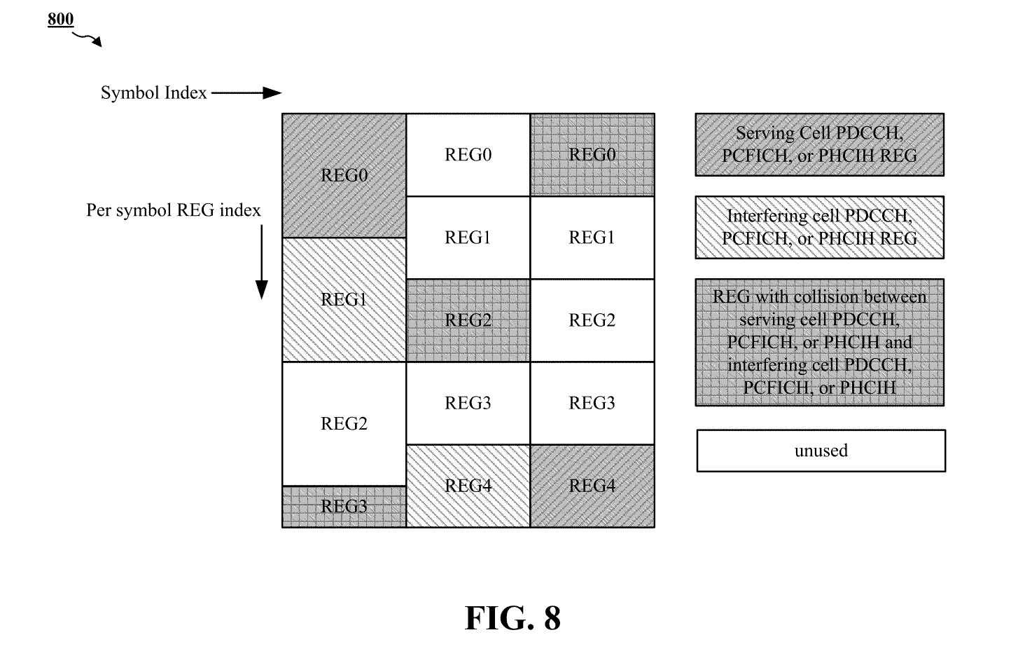

FIG. 8 is a schematic diagram 800 illustrating collisions and partial collision between a serving cell and an interfering cell for multiple REGs. Since the UE 705 has no knowledge of the RNTI of interfering cells, such as the RNTI of cells 720 and 730 of FIG. 7, the UE 705 does not know the location of the signal transmission from interfering cells 720 and 730. Thus, the received signal of the UE 705 may be expressed as the following four types according to different REG locations as depicted in FIG. 8. In other words, for each symbol, different REG sizes are allocated based on the following four signal types and when that symbol contains common reference signal.

Type 1: y=H₁x₁+n (for serving cell REGs)
Type 2: y=H₂x₂+n (for interfering cell REGs)
Type 3: y=H₁x₁+H₂x₂+n (for REG with collision between serving cell and interfering cell)
Type 4: y=n (unused REGs)

Indeed, in FIG. 8, the x-axis is the OFDM symbol index and y-axis is the tone index in frequency domain, where each box represents a REG. For example, for the first OFDM symbol in FIG. 8 contains common reference signal, so a REG consists of 6 tones. For the second and third symbol in FIG. 8, there is no common reference signal, so a REG consists of only 4 tones. It should also be noted that FIG. 7 uses only one OFDM symbol, as an example, which may signify that a REG consists of 6 tones.

Ideally the UE 705 may cancel the signals of interfering cell only in the area of the transmission where interference is present, thereby not introducing unexpected noise through unnecesary interference cancellation processes. Namely, the UE 705 may cancel the interference signals in the REGs where serving cell and interfering cell are colliding with each other, as in type 3.

In other words, UE 705 may receive a desired PDCCH, PCFICH, or PHCIH signal (type 1) from serving cell 710 while at the same time receiving a stronger PDCCH, PCFICH, or PHCIH interference signal (type 2) from neighboring second cell 720, resulting in total received PDCCH, PCFICH, or PHCIH signal (type 3). UE 705 may then determine the TPR of the PDCCH, PCFICH, or PHCIH signal (type 1) of serving cell 710 and the TPR of the PDCCH, PCFICH, or PHCIH signal (type 2) of neighboring second cell 720. UE 705 may then isolate resource blocks of the PDCCH, PCFICH, or PHCIH signal (type 1) of serving cell 710 and the resource blocks of the PDCCH, PCFICH, or PHCIH signal (type 2) of neighboring second cell 720. Afterwhich, the PDCCH, PCFICH, or PHCIH interference signal of neighboring second cell 720 (type 2) may then be canceled from the total received signal (type 3) by UE 705 in order to ensure that only the desired PDCCH, PCFICH, or PHCIH signal (type 1) from serving cell 710 is received.

Ideally, only the PDCCH, PCFICH, or PHCIH signals of interfering cell in the area where the interference really present should be canceled in order to avoid introducing unexpected noise. Namely, PDCCH, PCFICH, or PHCIH interference cancellation needs to apply to the REGs where serving cell PDCCH, PCFICH, or PHCIH and interfering cell PDCCH, PCFICH, or PHCIH are colliding with each other (in case 3). However, the location area where signals from the serving cell collide with signals from interfering cell is difficult to ascertain and, as such, PDCCH, PCFICH, or PHCIH interference cancellation must constantly be performed for all location areas.

Furthermore, given that the collision REGs location areas are not known and transmit power of PDCCH, PCFICH, or PHCIH may vary from REGs to REGs, aspects of this method and apparatus utilizes a ratio in a set of tones determined by the received signal and estimated channel based on common reference signal to predict: (1) whether the PDCCH, PCFICH, or PHCIH of interfering is present or not in order to make a decision as the whether interference cancellation is necessary and (2) how much the PDCCH, PCFICH, or PHCIH of interfering cell should be canceled and how much the residual power should be captured. Such set of tones may be in a unit of one REG for a cell and may also be a subset of one REG for a cell for non-colliding case. In other words, the ratio may be determinind based on the received signal on a set of tones (for example, one REG) and the channel estimate from the common reference signal. Note, the ratio computation requires both the received signal and the channel estimate.

In another aspect, UE 705 may also group the REGs and use a combination of ratios in a set of tones from those REGs to determine whether there is a transmission or not in those REGs. For example, UE 705 may utilize all REGs of a CCE belonging to the same OFDM symbol to determine whether there is a transmission or not in those REGs.

In yet another aspect, UE 705 may use this ratio in a set of tones to demodulate the PDCCH, PCFICH, or PHCIH and then use the resulted signal and common reference signal channel estimate to further determine a new and more reliable ratio by taking advantage of the Space Time Block Coding (SFBC) code structure with full diversity gain (e.g. for 2×2 case) for a set of tones. Again, this new and more reliable ratio could be used similarly to predict: (1) whether the PDCCH, PCFICH, or PHCIH of interfering is present or not in order to make a decision the interference cancellation is necessary and (2) how much the PDCCH, PCFICH, or PHCIH of interfering cell should be canceled and how much the residual power should be captured. Again, such set of tones may be in a unit of one REG for a cell and may also be a subset of one REG for a cell for non-colliding case.

As such, aspects of this apparatus and method include an approach whereby a TPR based on the receiver signal and common reference signal channel estimate is estimated for a set of tones of interfering cell and then be used to predict whether the PDCCH, PCFICH, or PHCIH is present or (if present) how much the PDCCH, PCFICH, or PHCIH of interfering cell should be cancelled and captured in the network to combat network mismatch. Additionally, this ratio could be further improved with aid of newly estimated PDCCH, PCFICH, or PHCIH symbols by taking advantage of SFBC code structure which provides full diversity gain. Moreover, if some potential transmit format information of PDCCH, PCFICH, or PHCIH is available at the receiver, this information could also be explored by adjusting the set of tones where the radio is estimated. This approach solves the major issue occurred in partial colliding PDCCH, PCFICH, or PHCIH interference scenario and this approach works well for any PDCCH, PCFICH, or PHCIH collision rate scenarios.

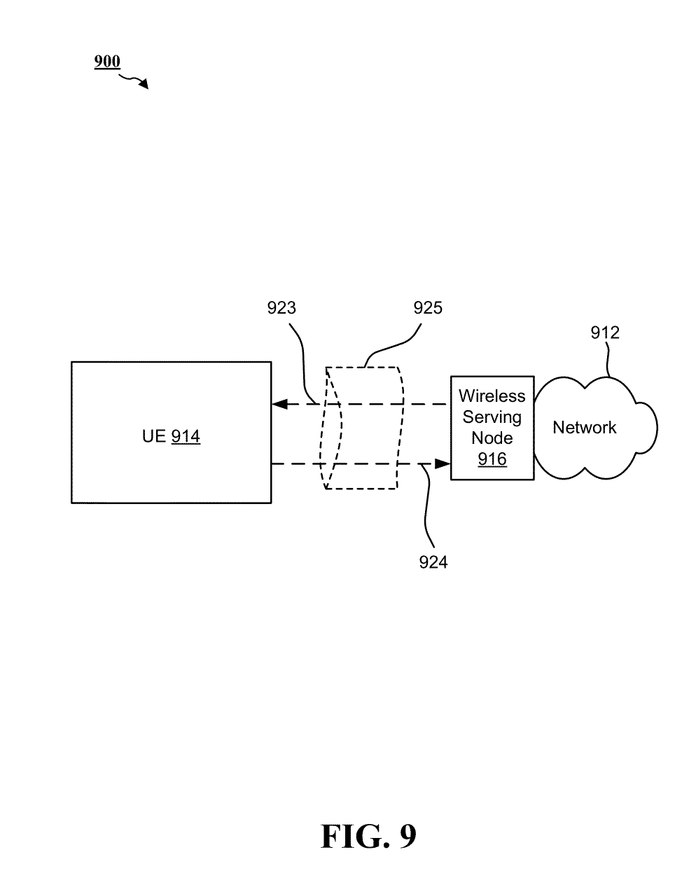

Referring to FIG. 9, in one aspect, a wireless communication system 900 is configured to facilitate transmitting data from a mobile device to a network at a fast data transfer rate. Wireless communication system 900 includes at least one UE 914 that may communicate wirelessly with one or more network 912 via serving nodes, including, but not limited to, wireless serving node 916 over one or more wireless link 925. The one or more wireless link 925, may include, but are not limited to, signaling radio bearers and/or data radio bearers. Wireless serving node 916 may be configured to transmit one or more signals 923 to UE 914 over the one or more wireless link 925, and/or UE 914 may transmit one or more signals 924 to wireless serving node 916. In an aspect, signal 923 and signal 924 may include, but are not limited to, one or more messages, such as transmitting a data packet from the UE 914 to the network via wireless serving node 916.

In an aspect, UE 914 may be configured to transmit a data to the wireless serving node 916 over wireless link 25. Specifically, in an aspect, UE 914 may be configured to receive a plurality of REGs, select a set of REGs from the plurality of REGs, and determine a TPR for the set of REGs.

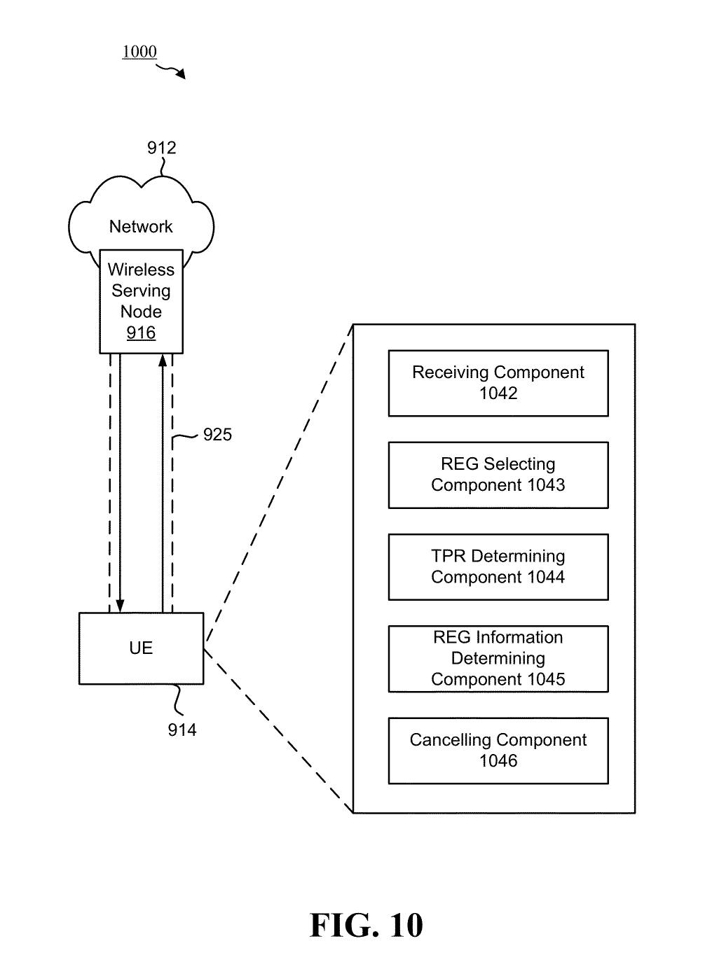

Referring to FIG. 10, in one aspect of the present apparatus and method, a wireless communication system 1000 is configured to include wireless communications between network 912 and UE 914. The wireless communications system may be configured to support communications between a number of users. FIG. 10 illustrates a manner in which wireless serving node 916, located in network 912 communicates with UE 914. The wireless communication system 1000 can be configured for downlink message transmission or uplink message transmission over wireless link 925, as represented by the up/down arrows between network 912 and UE 914.

In an aspect, UE 914 may be configured, among other things, to include a receiving component 1042 capable of receiving a transmission, the transmission including a plurality of REGs. UE 914 may also be configured to include a REG selecting component 1043 capable of selecting a set of REGs from the plurality of REGs, the set of REGs including at least one REG.

Further, UE 914 may be configured to include a TPR determining component 1044 capable of determining a TPR for the set of REGs based on the transmission and reference signals in the transmission. UE 914 may also be configured to include a REG information determining component 1045 capable of determining whether the set of REGs includes at least one of control information or data based on the TPR.

UE 914 may be configured to include a cancelling component 1046 canceling at least one of control information or data from the set of REGs based on the TPR.

UE 914 may also be configured such that processing by receiving component 1042, REG selecting component 1043, TPR determining component 1044, REG information determining component 1045, and cancelling component 1046 may also be performed on enhanced REG (eREG) in addition to normal REG.

The eREG may be defined as follows. Assuming a maximum presence of demodulation reference signal (DM-RS) in each physical resource block (PRB) pair, resource elements (REs) containing DM-RS are excluded from the eREG. Resource elements not containing DM-RS in the PRB pair are included in the eREG. For a normal cyclic prefix, 24 DM-RS resource elements exist. For an extended cyclic prefix, 16 DM-RS resource elements exist. Accordingly, for a normal cyclic prefix, the eREG includes 144 resource elements ((12 carriers×14 OFDM symbols)−24 DM-RS REs=144 REs). For an extended cyclic prefix, the eREG includes 128 resource elements ((12 carriers×12 OFDM symbols)−16 DM-RS REs=128 REs).

A PRB pair may be divided into 16 eREGs, regardless of a subframe type, cyclic prefix type, a PRB pair index, a subframe index, etc. For a normal cyclic prefix, an eREG may include 9 resource elements. For an extended cyclic prefix, an eREG may include 8 resource elements.

It should be noted that the mapping of an eREG to resource elements may follow a cyclic/sequential and frequency-first-time-second manner. This is beneficial to equalizing the number of available resource elements per eREG.

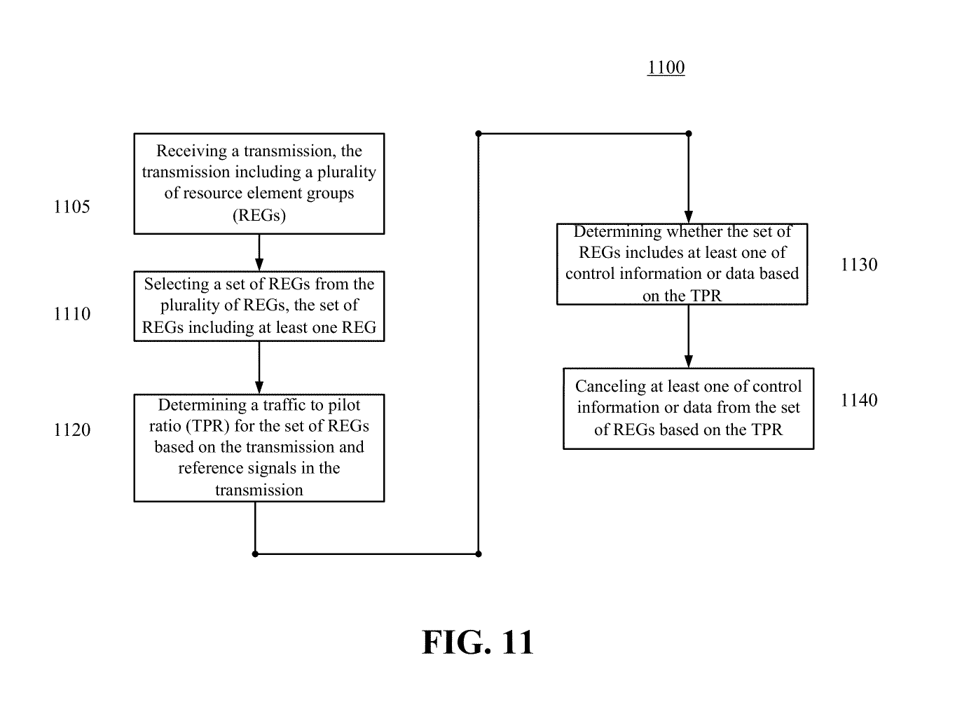

FIG. 11 is flow chart illustrating a first exemplary method of wireless communication between a UE and a cell. The method may be performed by UE 914. At step 1105, a UE receives a transmission, the transmission including a plurality of REGs. At 1110, the UE selects a set of REGs from the plurality of REGs, the set of REGs including at least one REG. Determining TPR for the set of REGs based on the transmission and reference signals in the transmission occurs at 1120.

At 1130, the UE determines whether the set of REGs includes at least one of control information or data based on the TPR. Finally, canceling at least one of control information or data from the set of REGs based on the TPR occurs at 1140.

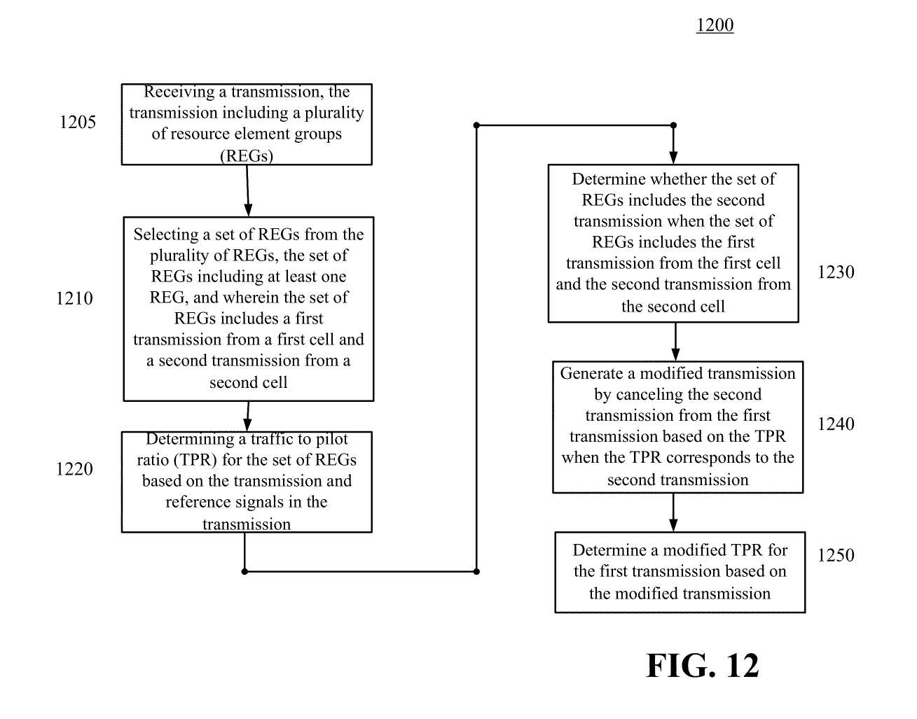

FIG. 12 is a flow chart illustrating a second exemplary method of wireless communication 1200 between a UE and a cell. At 1205, a UE receives a transmission, the transmission including a plurality of REGs. At 1210, the UE selects a set of REGs from the plurality of REGs, the set of REGs including at least one REG, and wherein the set of REGs includes a first transmission from a first cell and a second transmission from a second cell. Determining a TPR for the set of REGs based on the transmission and reference signals in the transmission occurs at 1220.

At 1230, the UE determines whether the set of REGs includes the second transmission when the set of REGs includes the first transmission from the first cell and the second transmission from the second cell. At 1240, the UE generates a modified transmission by canceling the second transmission from the first transmission based on the TPR when the TPR corresponds to the second transmission. Finally, determining a modified TPR for the first transmission based on the modified transmission occurs at 1250.

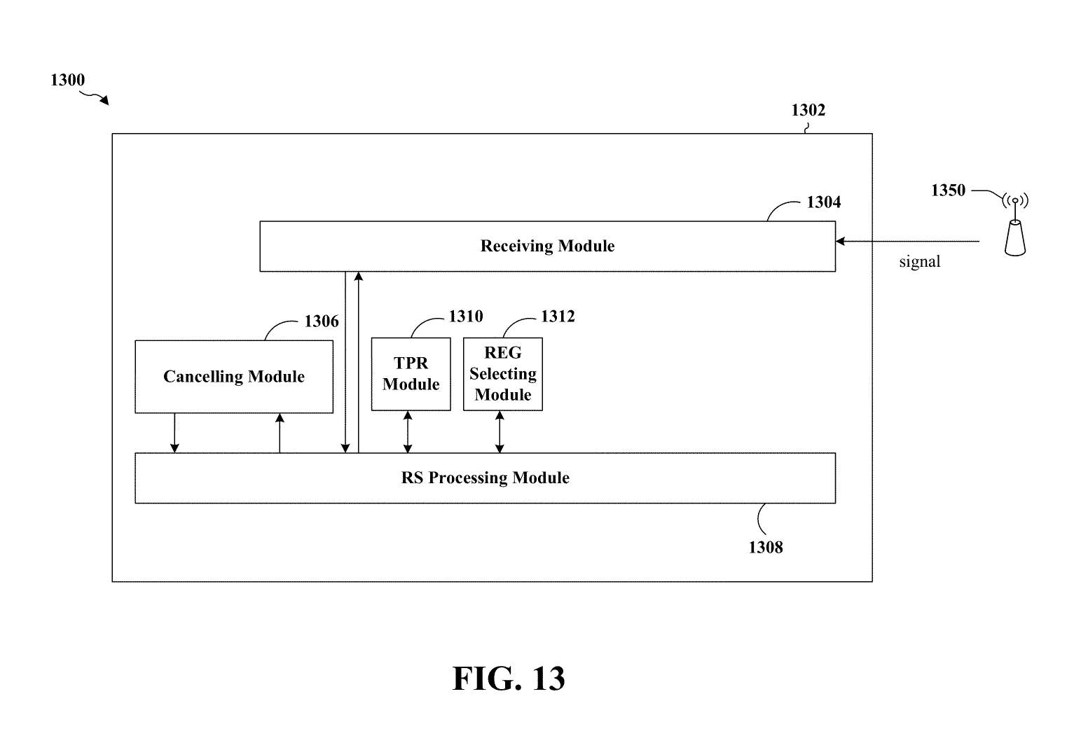

FIG. 13 is a conceptual data flow diagram 1300 illustrating the data flow between different modules/means/components in an exemplary apparatus 1302. The apparatus includes a receiving module 1304 that receives signals from the eNB 1350 in a plurality of OFDM symbols within subframes of a radio frame. The receiving module 1304 may receive processed RS signals from the RS processing module 1308.

The receiving module 1304 provides the received RS signals to a RS processing module 1308, which attempts to process the received RS signals. The RS processing module 1308 communicates with the TPR module 1310, REG Selecting module 1312, and Cancelling module 1306 to determine how the received RS signals are processed.

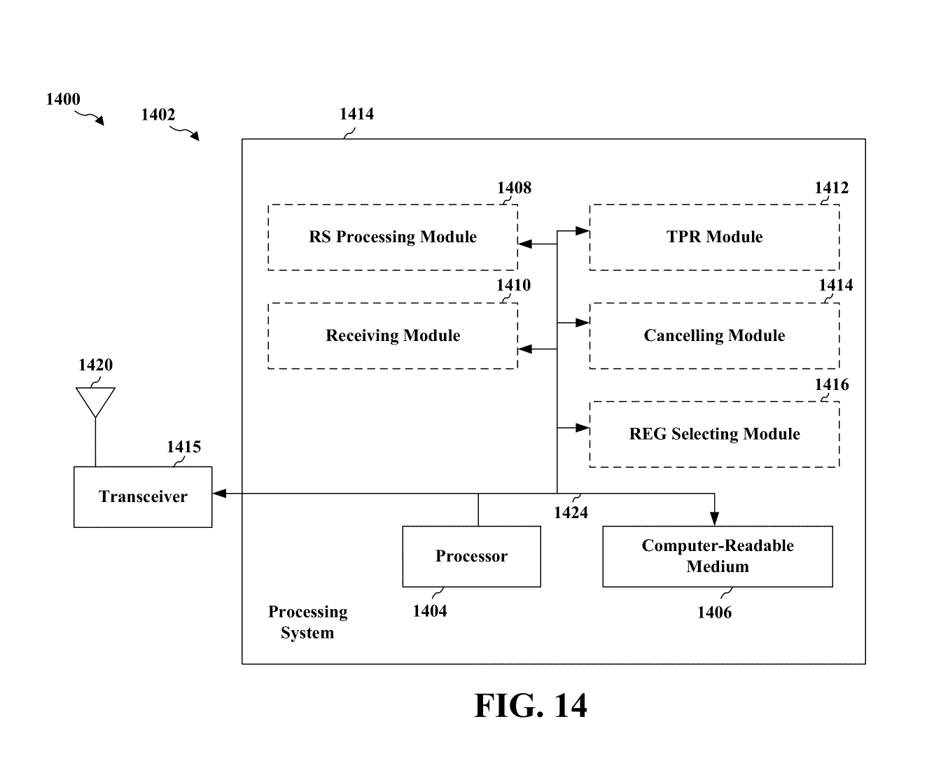

FIG. 14 is a diagram illustrating an example of a hardware implementation 1400 for an apparatus 1402 employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1408, 1410, 1412, 1414, 1416, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1415. The transceiver 1415 is coupled to one or more antennas 1420. The transceiver 1415 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1408, 1410, 1412, 1414, 1416. The modules may be software modules running in the processor 1404, resident/stored in the computer readable medium 1406, one or more hardware modules coupled to the processor 1404, or some combination thereof. The processing system 1414 may be a component of the UE 650 and may include the memory 660 and/or at least one of the TX processor 668, the RX processor 656, and the controller/processor 659.

In one configuration, the apparatus 1402 for wireless communication includes means for receiving a plurality of REGs, where each of the REGs includes reference signals. The apparatus further includes means for selecting a set of REGs from the plurality of REGs, where the set of REGs includes at least one REG. The apparatus further includes means for determining a TPR for the set of REGs based at least on the reference signals in the set of REGs. The apparatus may further include means for determining whether the set of REGs includes at least one of control information or data based on the TPR. The apparatus may further include means for cancelling at least one of control information or data from the set of REGs based on the TPR.

In another configuration, the apparatus 1402 for wireless communication includes means for receiving a plurality of REGs, where each of the REGs includes reference signals. The apparatus additionally includes means for selecting a set of REGs from the plurality of REGs, where the set of REGs including at least one REG. The apparatus further includes means for determining a TPR for the set of REGs based at least on the reference signals in the set of REGs. The apparatus may further include means for determining whether the set of REGs includes the second transmission, when the set of REGs includes a first transmission from a first cell and a second transmission from a second cell. Finally, the apparatus includes means for generating a modified transmission by canceling the second transmission from the first transmission based on the TPR, when the TPR corresponds to the second transmission, and means for determining a modified TPR for the first transmission based on the modified transmission.

The aforementioned means may be one or more of the aforementioned modules of the apparatus 1402 and/or the processing system 1414 of the apparatus 1402 configured to perform the functions recited by the aforementioned means. As described supra, the processing system 1414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving a transmission, the transmission including a plurality of resource element groups (REGs);
selecting a set of REGs from the plurality of REGs, the set of REGs including at least one REG; and
determining a traffic to pilot ratio (TPR) for the set of REGs based on the transmission and reference signals in the transmission;
determining whether the set of REGs includes at least one of control information or data based on the TPR;
canceling at least one of control information or data from the set of REGs based on the TPR.

2. The method of claim 1, wherein the transmission includes a plurality of eREGs.

3. The method of claim 1, further comprising selecting a subset of REGs from the plurality of REGs, the subset of REGs including at least one subset of one REG.

4. The method of claim 1, wherein canceling the at least one of control information includes isolating resource blocks of Physical Downlink Control Channel (PDCCH), Physical Control Format Indicator Channel (PCFICH), or Physical HybridARQ Indicator Channel (PHICH) signals from the set of REGs and cancelling the resource blocks of the PDCCH, PCFICH, or PHICH signals from the set of REGs.

5. The method of claim 4, wherein the PDCCH, PCFICH, or PHICH signals are transmitted in control regions of the plurality of REGs.

6. A method of wireless communication, comprising:
receiving a transmission, the transmission including a plurality of resource element groups (REGs);
selecting a set of REGs from the plurality of REGs, the set of REGs including at least one REG, and wherein the set of REGs includes a first transmission from a first cell and a second transmission from a second cell; and
determining a traffic to pilot ratio (TPR) for the set of REGs based on the transmission and reference signals in the transmission.

7. The method of claim 6, further comprising determining whether the set of REGs includes the second transmission when the set of REGs includes the first transmission from the first cell and the second transmission from the second cell.

8. The method of claim 6, wherein the TPR corresponds to the second transmission.

9. The method of claim 8, further comprising generating a modified transmission by canceling the second transmission from the first transmission based on the TPR when the TPR corresponds to the second transmission.

10. The method of claim 9, further comprising determining a modified TPR for the first transmission based on the modified transmission.

11. An apparatus for wireless communication, comprising:
at least one processor; and
a memory couple to the at least one processor, wherein the at least one processor is configured to:
receive a transmission, the transmission including a plurality of resource element groups (REGs);
select a set of REGs from the plurality of REGs, the set of REGs including at least one REG; and
determine a traffic to pilot ratio (TPR) for the set of REGs based on the transmission and reference signals in the transmission;
determine whether the set of REGs includes at least one of control information or data based on the TPR;
cancel at least one of control information or data from the set of REGs based on the TPR.

12. The apparatus of claim 11, wherein the transmission includes a plurality of eREGs.

13. The apparatus of claim 11, wherein the at least one processor is further configured to select a subset of REGs from the plurality of REGs, the subset of REGs including at least one subset of one REG.

14. The apparatus of claim 11, wherein the at least one processor configured to cancel the at least one of control information is further configured to isolate resource blocks of Physical Downlink Control Channel (PDCCH), Physical Control Format Indicator Channel (PCFICH), or Physical HybridARQ Indicator Channel (PHICH) signals from the set of REGs and cancel the resource blocks of the PDCCH, PCFICH, or PHICH signals from the set of REGs.

15. The apparatus of claim 14, wherein the PDCCH, PCFICH, or PHICH signals are transmitted in control regions of the plurality of REGs.

16. An apparatus for wireless communication, comprising:
at least one processor; and
a memory couple to the at least one processor, wherein the at least one processor is configured to:
receive a transmission, the transmission including a plurality of resource element groups (REGs);
select a set of REGs from the plurality of REGs, the set of REGs including at least one REG, and wherein the set of REGs includes a first transmission from a first cell and a second transmission from a second cell; and
determine a traffic to pilot ratio (TPR) for the set of REGs based on the transmission and reference signals in the transmission.

17. The apparatus of claim 16, wherein the at least one processor is further configured to determine whether the set of REGs includes the second transmission when the set of REGs includes the first transmission from the first cell and the second transmission from the second cell.

18. The apparatus of claim 16, wherein the TPR corresponds to the second transmission.

19. The apparatus of claim 18, wherein the at least one processor is further configured to generate a modified transmission by canceling the second transmission from the first transmission based on the TPR when the TPR corresponds to the second transmission.

20. The apparatus of claim 19, wherein the at least one processor is further configured to determine a modified TPR for the first transmission based on the modified transmission.

21. An apparatus for wireless communication, comprising:
means for receiving a transmission, the transmission including a plurality of resource element groups (REGs);
means for selecting a set of REGs from the plurality of REGs, the set of REGs including at least one REG; and
means for determining a traffic to pilot ratio (TPR) for the set of REGs based on the transmission and reference signals in the transmission;
means for determining whether the set of REGs includes at least one of control information or data based on the TPR;
means for canceling at least one of control information or data from the set of REGs based on the TPR.

22. The apparatus of claim 21, wherein the transmission includes a plurality of eREGs.

23. The apparatus of claim 21, further comprising means for selecting a subset of REGs from the plurality of REGs, the subset of REGs including at least one subset of one REG.

24. The apparatus of claim 21, wherein means for canceling the at least one of control information includes means for isolating resource blocks of Physical Downlink Control Channel (PDCCH), Physical Control Format Indicator Channel (PCFICH), or Physical HybridARQ Indicator Channel (PHICH) signals from the set of REGs and means for cancelling the resource blocks of the PDCCH, PCFICH, or PHICH signals from the set of REGs.

25. The apparatus of claim 24, wherein the PDCCH, PCFICH, or PHICH signals are transmitted in control regions of the plurality of REGs.

26. An apparatus for wireless communication, comprising:
means for receiving a transmission, the transmission including a plurality of resource element groups (REGs);
means for selecting a set of REGs from the plurality of REGs, the set of REGs including at least one REG, and wherein the set of REGs includes a first transmission from a first cell and a second transmission from a second cell; and
means for determining a traffic to pilot ratio (TPR) for the set of REGs based on the transmission and reference signals in the transmission.

27. The apparatus of claim 26, further comprising means for determining whether the set of REGs includes the second transmission when the set of REGs includes the first transmission from the first cell and the second transmission from the second cell.

28. The apparatus of claim 26, wherein the TPR corresponds to the second transmission.

29. The apparatus of claim 28, further comprising means for generating a modified transmission by canceling the second transmission from the first transmission based on the TPR when the TPR corresponds to the second transmission.

30. The apparatus of claim 29, further comprising means for determining a modified TPR for the first transmission based on the modified transmission.

31. A computer program product for wireless communication, comprising:
a computer readable medium comprising code executable by a computer for:
receiving a transmission, the transmission including a plurality of resource element groups (REGs);
selecting a set of REGs from the plurality of REGs, the set of REGs including at least one REG; and
determining a traffic to pilot ratio (TPR) for the set of REGs based on the transmission and reference signals in the transmission;
determining whether the set of REGs includes at least one of control information or data based on the TPR;
canceling at least one of control information or data from the set of REGs based on the TPR.

32. The computer program product of claim 31, wherein the transmission includes a plurality of eREGs.

33. The computer program product of claim 31, further comprising code for selecting a subset of REGs from the plurality of REGs, the subset of REGs including at least one subset of one REG.

34. The computer program product of claim 31, wherein code for canceling the at least one of control information includes code for isolating resource blocks of Physical Downlink Control Channel (PDCCH), Physical Control Format Indicator Channel (PCFICH), or Physical HybridARQ Indicator Channel (PHICH) signals from the set of REGs and code for cancelling the resource blocks of the PDCCH, PCFICH, or PHICH signals from the set of REGs.

35. The computer program product of claim 34, wherein the PDCCH, PCFICH, or PHICH signals are transmitted in control regions of the plurality of REGs.

36. A computer program product for wireless communication, comprising:
a computer readable medium comprising code executable by a computer for:
receiving a transmission, the transmission including a plurality of resource element groups (REGs);
selecting a set of REGs from the plurality of REGs, the set of REGs including at least one REG, and wherein the set of REGs includes a first transmission from a first cell and a second transmission from a second cell; and
determining a traffic to pilot ratio (TPR) for the set of REGs based on the transmission and reference signals in the transmission.

37. The computer program product of claim 36, further comprising code for determining whether the set of REGs includes the second transmission when the set of REGs includes the first transmission from the first cell and the second transmission from the second cell.

38. The computer program product of claim 36, wherein the TPR corresponds to the second transmission.

39. The computer program product of claim 38, further comprising code for generating a modified transmission by canceling the second transmission from the first transmission based on the TPR when the TPR corresponds to the second transmission.

40. The computer program product of claim 39, further comprising code for determining a modified TPR for the first transmission based on the modified transmission.
